(19) United States
(12) Patent Application Publication
(10) Pub. No.: US 2022/0356587 A1
(43) Pub. Date: Nov. 10, 2022

(54) OPTIMISED COMPRESSION HIGH TEMPERATURE ELECTROLYSER SYSTEM

(71) Applicant: COMMISSARIAT A L'ENERGIE ATOMIQUE ET AUX ENERGIES ALTERNATIVES, Paris (FR)

(72) Inventors: Nicolas TAUVERON, Grenoble Cedex 09 (FR); Pierre DUMOULIN, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/736,360

(22) Filed: May 4, 2022

(30) Foreign Application Priority Data
May 4, 2021 (FR) 21 04678

(51) Int. Cl. C25B 1/042; C25B 15/021; C25B 15/08

(52) U.S. Cl. CPC C25B 1/042; C25B 15/021; C25B 15/08

(57) ABSTRACT

A system includes a high temperature electrolyser, a first line for supplying the electrolyser to supply the electrolyser with steam, a first line for discharging the electrolyser to discharge dihydrogen from the electrolyser, a second line for discharging the electrolyser to discharge dioxygen from the electrolyser, a first heat exchange module to ensure a heat exchange between the first steam supply line and the first dihydrogen discharge line. The system also includes a steam ejector arranged downstream from the first heat exchange module on the first dihydrogen discharge line to inject steam into the first dihydrogen discharge line. The system relates to the field of high temperature electrolysis of water, also with solid oxide and that of solid oxide fuel cells. It applies particularly to optimise the energy consumption of an SOEC electrolyser system.

### TECHNICAL FIELD

The present invention relates to the field of high temperature electrolysis of water (HTE, or HTSE for high temperature steam electrolysis), also with solid oxide (SOEC, solid oxide electrolyte cell) and that of solid oxide fuel cells (SOFC). It has an application particularly for optimising the energy consumption of an SOEC electrolyser system.

### STATE OF THE ART

The electrolysis of water is an electrolytic reaction which breaks down water into dioxygen and gaseous dihydrogen using an electric current according to the reaction: H2O→H2+½O2.

To perform the electrolysis of water, it is advantageous to do it at a high temperature, typically between 600 and 950° C., as some of the energy necessary for the reaction can be applied by heat, which is cheaper than electricity and the activation of the reaction is more effective at a high temperature, and does not require any catalyst. A solid oxide electrolyte cell or “SOEC” in particular comprises: a first porous conductive electrode, or “cathode”, intended to be supplied with steam for producing dihydrogen, a second porous conductive electrode, or “anode”, by which the dioxygen produced by the electrolysis of the water injected onto the cathode escapes, and a solid oxide membrane (dense electrolyte) sandwiched between the cathode and the anode, the membrane being an anionic conductor for high temperatures, usually temperatures greater than 600° C. By heating the cell at least at this temperature and by injecting an electric current I between the cathode and the anode, thus a reduction of water on the cathode occurs, which generates dihydrogen (H2) on the cathode and dioxygen on the anode.

To perform high temperature steam electrolysis THE, the steam H2O is injected in the cathode compartment.

Under the effect of the current applied to the cell, the separation of the water molecules in steam form is performed at the interface between the hydrogen electrode (cathode) and the electrolyte: this separation produces dihydrogen gas H2 and oxygen ions. Dihydrogen is collected and discharged at the outlet of the hydrogen compartment.

The oxygen ions migrate through the electrolyte and is recombined with dioxygen O2 at the interface between the electrolyte and the oxygen electrolyte (anode).

For the effective implementation of electrolysis by the stack, the stack is brought to a temperature greater than 600° C., usually a temperature of between 600° C. and 950° C., the gas supply is switched on at constant flow and an electric supply source is connected between two terminals of the stack in order to make the current I circulate there.

The yield of the electricity transformation into hydrogen is a key point in order to ensure the competitivity of the technology. Electric consumption has mainly occurred, strictly speaking during the electrolysis reaction, but almost 30% of the consumption of the electrolyser comes from the fluid thermal/hydraulic management system, i.e. the architecture external to the electrolyser and the management of fluids and of the thermal energy in this architecture.

A significant portion of the consumption of the system comes from the fluid thermal/hydraulic management system, in particular from the compression of hydrogen. Indeed, the SOEC produces low-pressure hydrogen, or more accurately, a mixture of water and dihydrogen, a mixture that must be separated and compressed until a usage pressure. The optimisation of the electric yield of the system therefore passes, in particular, through an optimisation of this compression chain.

There is therefore a need to minimise this consumption by optimising the architecture and the management of the fluids of the system of the electrolyser.

An aim of the present invention is therefore to propose an optimised compression high temperature electrolyser system.

Other aims, characteristics and advantages of the present invention will appear upon examining the following description and the accompanying drawings, it is understood that other advantages can be incorporated.

### SUMMARY

To achieve this aim, according to an embodiment, a system is provided, comprising
a high temperature electrolyser (HTE),
a first supply line of the electrolyser configured to supply the electrolyser with steam,
a first discharge line of the electrolyser configured to discharge dihydrogen from the electrolyser,
a second discharge line of the electrolyser configured to discharge dioxygen from the electrolyser,
a first heat exchange module configured to ensure a heat exchange between the first steam supply line and the first dihydrogen discharge line,
   characterised in that the system comprises a steam ejector arranged downstream from the first heat exchange module on the first discharge line and configured to inject steam into the first dihydrogen discharge line.

The ejector participates in compressing the dihydrogen produced and therefore allows to decrease the significance of the compressors to reach the storage pressure of the dihydrogen. The compressors are bulky members and consume a lot of electric energy. The compression, in particular, at the start of the compression, to double the atmospheric pressure consumes a lot of energy. The presence of the ejector therefore allows a reduction of electricity consumption.

The present invention allows to use the available steam to partially compress the hydrogen by using a thermocompression method: an ejector.

Using an ejector allows to reduce the compression needs by compressors and therefore to decrease the general electric consumption of the system. Using available steam for its injection by an ejector by mixing it with the hydrogen produced by the SOEC is possible, as the hydrogen flow produced already contains some of the steam. Injecting additional steam is therefore possible.

### BRIEF DESCRIPTION OF THE FIGURES

The aims, objectives, as well as the characteristics and advantages of the invention will emerge best from the detailed description of an embodiment of the latter, which is illustrated by the following accompanying drawing:

FIG. 1 is a functional diagram representing the system according to the invention.

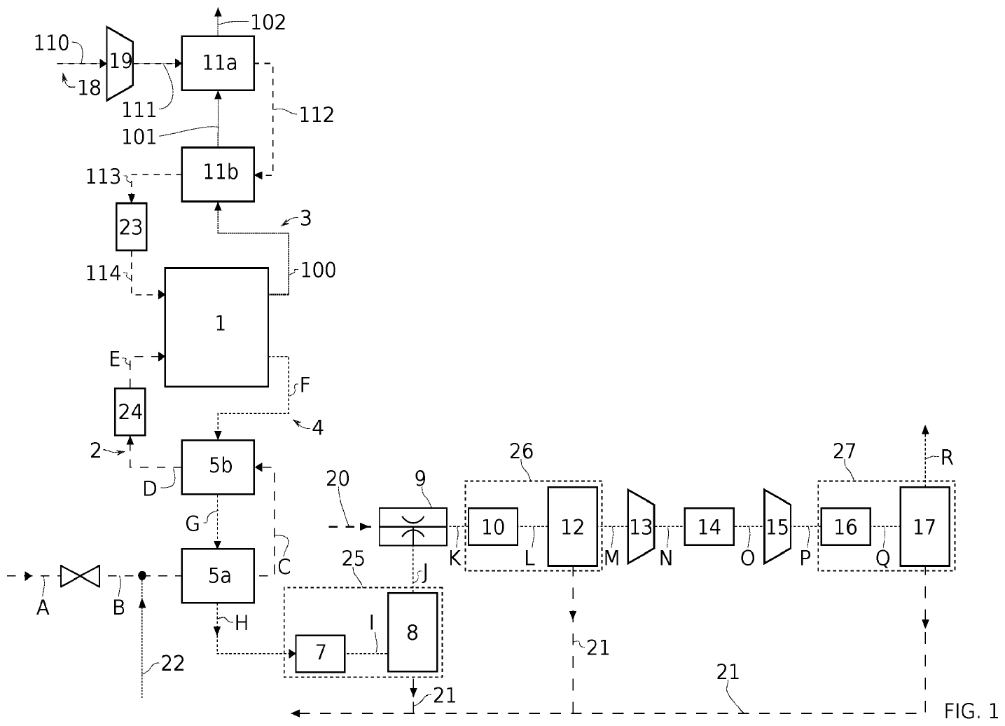

The drawings are given as examples and are not limiting of the invention. They constitute schematic principle representations intended to facilitate the understanding of the invention, and are not necessarily to the scale of practical applications.

### DETAILED DESCRIPTION

Before starting a detailed review of embodiments of the invention, below are stated optional characteristics, which can possibly be used in association or alternatively:

According to an example, the system comprises at least one compressor 13, 15 arranged downstream from the ejector 9. The compressor allows to continue the compression of dihydrogen to a target pressure.

According to an example, the system comprises at least two compressors 13, 15 arranged in series and a heat exchanger 14 arranged between two compressors 13, 15. The compressors in series spaced apart by the heat exchanger allow an increase in pressure of dihydrogen, while ensuring between the compressions, a lowering of the temperature in view of another compression. According to a possibility, a separator is also arranged between the two compressors, preferably after the heat exchanger, if liquid water is condensed during the cooling phase of the mixture.

According to an example, the system comprises at least two ejectors 9 arranged in series.

Preferably, the system comprises a treatment stage which is arranged between two ejectors. The treatment stage allows to reduce the quantity of water in the mixture and therefore to reduce the flow rate of the flow to allow another compression. The treatment stage comprises a heat exchanger and/or a liquid/gas separator.

According to an example, the system comprises a first stage for treating 26 dihydrogen arranged on the first dihydrogen discharge line 4 downstream from the ejector 9.

According to an example, the compressor 13 is arranged downstream from the first treatment stage 26. This position of the compressor allows to make it function on a lower flow rate due to the drying and the cooling of the flow by the treatment stage.

According to an example, the first treatment stage comprises a heat exchanger 10 and/or a liquid/gas separator 12.

According to an example, the system comprises a preliminary stage for treating the dihydrogen arranged on the first dihydrogen discharge line 4 upstream from the ejector 9.

According to an example, the system comprises a second stage for treating 27 the dihydrogen arranged on the first dihydrogen discharge line 4 downstream from the compressor 13, 15.

Preferably, the system comprises a third stage for treating dihydrogen arranged on the first dihydrogen discharge line 4 downstream from the second treatment stage 27.

According to an example, the system comprises a second line for supplying 10 the electrolyser configured to supply the electrolyser 1 with air.

According to an example, the system comprises a second heat exchange module 11 configured to ensure a heat exchange between the second air supply line 10 and the second dioxygen discharge line 3.

According to an example, the system comprises a water recycling line 21 fluidly connected to at least one from among the preliminary treatment stage, the first treatment stage and the second treatment stage.

According to an example, the steam is fatal steam. The steam is at a temperature of 150° C.

According to an aspect, the invention relates to a method for treating the dihydrogen produced by a high temperature electrolyser 1 such as described above, comprising a step of injecting steam by an ejector 9 into the first dihydrogen discharge line, preferably downstream from a first heat exchange module 5. Upstream and downstream, the inlet, the outlet, in a given point are taken in reference to the circulation direction of the fluid.

By a parameter “substantially equal to/greater than/lower than” a given value, this means that this parameter is equal to/greater than/lower than the given value, by 10% more or less 10%, even 5% more or less, of this value.

The system according to the invention comprises a high temperature electrolyser (HTE) 1. Preferably, the electrolyser 1 is of the SOEC (solid oxide electrolyte cell) type, i.e. with a solid oxide.

The system comprises several supply and discharge lines connected to the electrolyser 1. Thus, by line, this means a conduit, a tube or a set of conduits or tubes which allow the transport of fluid to and from the electrolyser 1.

The system according to the invention comprises a first line for supplying 2 the electrolyser 1 capable of supplying the electrolyser 1 with steam. According to a possibility, the first supply line 2 is configured to provide the electrolyser 1 with steam, by this, this means that the first supply line 2 can provide a mixture of steam and other gas(es), for example air or dihydrogen or carbon dioxide. According to a preferred possibility, the steam circulating in the first supply line 2 is at least partially fatal steam, for example at a temperature of 150° C. The fatal steam comes from, for example, industrial methods. The advantage of this solution is to enhance the fatal energy, reducing the energy cost of the electrolysis system. According to another possibility, upstream in this first supply line 2, the steam is not yet formed and the first supply line 2 is configured to receive liquid water. According to this possibility, the first supply line 2 comprises a first portion receiving liquid water and a second portion receiving steam. Preferably, the first portion is located upstream from a steam generator and the second portion is located downstream from said steam generator.

According to this possibility, the system according to the invention comprises a steam generator. The steam generator is intended to produce steam from liquid water. The steam generator is supplied with energy to ensure the increase in temperature of the liquid water above its evaporation temperature. The steam generator is arranged on the first steam supply line.

The system according to the invention comprises a first discharge line 4 capable of discharging dihydrogen (H₂) from the electrolyser 1. Preferably, the first discharge line 4 receives dihydrogen. Dihydrogen is advantageously produced by the electrolyser 1. The dihydrogen is in gaseous form. The first discharge line 4 can discharge a mixture of dihydrogen and steam, called residual, not having been broken down by the electrolyser 1.

The system according to the invention comprises a second discharge line 3 capable of discharging dioxygen (O₂) from the electrolyser 1. Preferably, the second discharge line 3 receives dioxygen. The dioxygen is advantageously produced by the electrolyser 1. The dioxygen is in gaseous form. The second discharge line 3 discharges, according to a possibility, a dioxygen-enriched gas, for example dioxygen-enriched air.

Below in the description, the first supply line 2 is called first steam supply line 2, the first discharge line 4 is called first dihydrogen discharge line 4 and the second discharge line 3 is called second dioxygen discharge line 3, without being limiting on the gas, the fluid, or the mixture which could be transported in these lines.

According to a possibility, the system comprises a first heat exchange module 5 configured to ensure a heat exchange between the first steam supply line 2 and the first dihydrogen discharge line 4. This heat exchange module is configured to transfer the calories from the dihydrogen coming from the electrolyser 1 to the steam intended to supply the electrolyser 1. A dihydrogen gas flow ensures the increase in temperature of the steam flow while also allowing to cool the discharged dihydrogen flow and which is advantageously dried and/or compressed in view of its use.

The first heat exchange module 5 comprises according to an embodiment, at least one heat exchanger 5a configured to ensure the heat transfer of the dihydrogen to the steam. According to a preferred embodiment, the first heat exchange module 5 comprises two heat exchangers 5a, 5b arranged in series between the first supply line 2 and the first discharge line 4. This arrangement allows to provide a second heat exchanger 5b adapted to the temperature of the dihydrogen at the outlet of the electrolyser 1, conventionally of around 700° C., and a more usual first heat exchanger 5a adapted to the temperature of the dihydrogen after the passage into a heat exchanger. In this way, the components are optimised for the temperatures and heat transfers to be performed.

According to an embodiment, the system comprises a second supply line 18, capable of supplying the electrolyser 1 with air. Preferably, the second supply line 18 receives the air. According to a possibility, the second supply line 18 is configured to provide air to the electrolyser 1, by this, this means that the second supply line 18 can provide air, the air being, for example, a gaseous mixture which allows to sweep the cell of the electrolyser 1 and to remove the dioxygen produced by the electrolyser 1.

According to this embodiment, it is advantageous that the system according to the invention comprises a second heat exchange module 11 configured to ensure a heat exchange between the second air supply line 18 and the second dioxygen discharge line 3. This heat exchange module 11 is configured to transfer the calories of the dioxygen coming from the electrolyser 1 to the air intended to supply the electrolyser 1. A dioxygen gas flow ensures the increase in temperature of the airflow which also allows to cool the discharged dioxygen flow.

The second heat exchange module 11 comprises, according to an embodiment, at least one heat exchanger 11a configured to ensure the heat transfer from the dioxygen to the air. According to a preferred embodiment, the second heat exchange module 11 comprises two heat exchangers 11a, 11b arranged in series between the second supply line 18 and the second discharge line 3. This arrangement allows to provide a second heat exchanger 11b adapted to the temperature of the dioxygen at the outlet of the electrolyser 1, conventionally of around 700° C., and a more usual first heat exchanger 11a adapted to the temperature of the dioxygen after the passage into a heat exchanger. In this way, the components are optimised for the temperatures and heat transfer to be performed.

The system preferably comprises a compressor 19 arranged on the second supply line 18 intended to supply with air. The compressor 19 is preferably arranged upstream from the second heat exchange module 11 if it is present. The compressor 19 is intended to ensure the compression of the air intended to be supplied to the electrolyser 1. The compression of the air advantageously contributes to increasing the temperature of the air before it enters into the electrolyser 1.

According to a possibility, the system comprises at least one complementary heat source configured to heat the steam entering into the electrolyser 1 up to a predefined target temperature. The complementary heat source is advantageously arranged on the first steam supply line 2, preferably downstream from the first heat exchange module 5. The complementary heat source is, for example, an electrical heater 24.

According to a possibility, the system comprises at least one complementary heat source configured to heat the air entering into the electrolyser 1 up to a predefined target temperature. The complementary heat source is advantageously arranged on the second air supply line 18, preferably downstream from the second heat exchange module 11. The complementary heat source is, for example, an electrical heater 23.

Advantageously, the dihydrogen discharged from the electrolyser 1 is at almost atmospheric pressure. Yet, storing dihydrogen is preferably done in a compressed manner, for example, at a pressure of around 30 bars, that is 3 MPa.

The system according to the invention advantageously comprises different means, such as a compression chain, arranged on the dihydrogen discharge line 4 to compress the dihydrogen and reach a pressure compatible with its storage.

According to an aspect, the invention comprises an ejector 9 arranged on the first dihydrogen discharge line 4.

An ejector 9 is configured to introduce a high pressure fluid into a lower pressure fluid, such that the higher pressure fluid leads to the lower pressure fluid. The ejector 9 is also called jet pump. The ejector 9 is advantageous, as it is not very bulky and requires little maintenance, in that it does not comprise any movable part.

The ejector 9 is supplied by a steam source, preferably a steam (water vapour) source, preferably a fatal steam. The steam is advantageously low-temperature of around, for example, 150° C. The steam source supplying the ejector 9 is advantageously the same as that supplying the first supply line 2 with steam. The ejector 9 utilises the Venturi effect and allows the use of the steam source to compress the dihydrogen discharged into the first dihydrogen discharge line 4.

According to an embodiment, the system comprises at least one ejector 9, more specifically at least two ejectors. In this case, the ejectors 9 are arranged in series. Preferably, the ejectors are separated by at least one heat exchanger and/or a liquid/gas separator. The presence of a heat exchanger and/or a liquid/gas separator between the ejectors allows to reduce the temperature of the circulating fluid, advantageously of the dihydrogen mixed with water, and/or to remove the water from the dihydrogen. This arrangement also allows to skip controlled pressure.

The ejector 9 is configured to increase the pressure of the hydrogen flow, preferably the first increase in pressure of the dihydrogen flow produced.

According to an embodiment, the system can comprise a module for storing steam upstream from the ejector 9 and/or upstream from the first steam supply line 2 so as to smoothen the heat source supplying the ejector 9 and/or the first supply line 2.

According to a possibility, the system comprises at least one compressor 13, 15 arranged on the first dihydrogen discharge line 4, preferably downstream from the ejector 9. The system can comprise at least two compressors 13, 15 arranged on the first dihydrogen discharge line 4. Preferably, the compressors 13, 15 are arranged in series, more preferably the system comprises a heat exchanger 14, such as an air cooler arranged between two compressors 13, 15. The presence of an air cooler-type heat exchanger, for example between the compressors 13, 15 allows to ensure a decrease in temperature of the circulating fluid from one compressor 13 to the other compressor 15, and therefore a decrease in pressure and its flow rate facilitating the work of the following compressor 15.

As an example, the ejector 9 ensures the compression of the fluid from 0.9 bar to 1.6 bar, that is from 0.09 MPa to 0.16 MPa. At least one compressor 13, 15 thus ensures the compression of the fluid between 1.6 bar and 10 bar instead of between 0.9 bar and 10 bar. In the case where the pressure of the dihydrogen must also be increased, the system comprises other conventional compression and treatment steps to reach the target pressure.

According to an embodiment, the system comprises means for treating the dihydrogen flow produced. The dihydrogen produced by the electrolyser 1 and which emerges from it by the first discharge line 4 first has a very high temperature corresponding to the reaction temperature of the electrolyser 1. Yet, in view of its use, the dihydrogen must preferably be brought to a temperature close to ambient temperature. Moreover, the dihydrogen discharged from the electrolyser 1 by the first discharge line 4 can comprise the steam removed with the dihydrogen flow. It is therefore also preferred to separate the dihydrogen from the possible steam removed with it, by drying it.

The system according to the invention advantageously comprises, to this end, at least one preliminary treatment stage 25 intended to dry and/or compress the dihydrogen produced.

According to a possibility, the preliminary treatment stage 25 comprises a heat exchanger 7, such as an air cooler or a condenser or a cooler. The heat exchanger 7 is arranged on the first discharge line 4, preferably downstream from the first heat exchanger module 5.

The air cooler is a heat exchanger between a fluid and a gas, the gas being moved by a ventilator. According to another possibility, the air cooler is replaced by a standard cooler or a condenser, i.e. without a ventilator, this solution however being less effective. Below in the description, the term “air cooler” is used, without being limiting, the air cooler could be replaced by a standard cooler, or a condenser, with no difficulty.

The preliminary treatment stage 25 advantageously comprises a liquid/gas separator 8 downstream from the air cooler 7. The separator 8 allows to separate the liquid water from the gaseous dihydrogen, the liquid water resulting from the cooling of the steam in the air cooler 7 below its condensation point. The separator 8 therefore contributes to reducing the flow rate of the circulating flow and therefore the energy necessary for the compression.

According to a preferred possibility, the system comprises a first treatment stage 26 arranged downstream from the preliminary treatment stage 25 on the first discharge line 4. The first treatment stage 26 contributes to the drying of the dihydrogen. The first treatment stage 26 advantageously comprises a heat exchanger, preferably an air cooler 10. The first treatment stage 26 comprises a liquid/gas separator 12. Preferably, the system comprises, between the preliminary treatment stage 25 and the first treatment stage 26, the ejector 9. Thus, after the ejector 9, the first treatment stage 26 allows to reduce the quantity of water injected into the dihydrogen flow, while the preliminary treatment stage 25 is configured to lower the temperature of the circulating flow of the dihydrogen produced, and to enrich the circulating flow of dihydrogen before reinjecting steam by the ejector 9.

The first treatment stage 26 is advantageously performed at a pressure of 1.6 bar, pressure at the outlet of the ejector 9. The first treatment stage 26 thus allows to have a hydrogen-enriched gaseous phase and therefore to decrease the compressed flow rate.

Preferably, the first treatment stage 27 is arranged upstream from the at least one compressor 13, 15.

Advantageously, at least one compressor 13 arranged downstream from the first treatment stage 26 can have a reduced electric power which is an advantage from the standpoint of the cost and of the use of electricity.

From the preliminary treatment stage 25 and/or the first treatment stage 26, if present, the liquid water is preferably recycled, for example, by being returned to the first steam supply line 2 by a water recycling line 21. The water recycling line can be fluidly connected to the first supply line 2, preferably in the case where an inlet of steam produced by a steam generator is desired. In this case, the recycling line 21 is connected to the steam supply line 2 upstream from the steam generator.

According to a preferred possibility, the system comprises a second treatment stage 27 arranged downstream from the first treatment stage on the first discharge line 4. The second treatment stage 27 allows to complete the drying of the dihydrogen. The second treatment stage 27 advantageously comprises, preferably an air cooler 16, or which, as for the other stages, can be a standard cooler. The second treatment stage 27 preferably comprises a liquid/gas separator 17.

Preferably, the second treatment stage 27 is arranged downstream from the at least one compressor 13, 15.

The invention advantageously applies when low-temperature steam is available. By low-temperature steam, this means a steam having a temperature of around 150° C.

As an example, the invention is advantageous in cases where a low-temperature steam is abundant and inexpensive, such as a non-enhanced low-temperature steam coming from an industrial method or a waste incinerator, or possibly a heat network, or also a low-temperature steam coming from geothermal sources or a thermal solar source. Interest must be highlighted in the case of solar with a photovoltaic part to supply the electricity associated with a heat source (thermal solar). In addition, the invention is particularly advantageous in that this temperature range is quite common and hardly has an enhancement method.

The electrolyser 1 receives steam and advantageously air, and releases dihydrogen and dioxygen.

Preferably, the electrolyser 1 is fluidly connected to the first steam supply line 2. The first steam supply line 2 ensures the fluid connection of components arranged upstream from the electrolyser 1 on said supply line 2. The following description is made by starting upstream from the electrolyser 1 and by following the circulation direction in the first supply line 2. Preferably, the first supply line 2 ensures the fluid connection to an expansion valve 6. Then, the first supply line 2 ensures the fluid connection of the steam to the first heat exchange module 5, preferably to the first heat exchanger 5a, then the fluid connection of the first heat exchanger 5a to the second heat exchanger 5b, then the fluid connection of the second heat exchanger 5b to the electrical heater 24, then the fluid connection of the electrical heater 24 to the electrolyser 1.

Preferably, the electrolyser 1 is fluidly connected to a first dihydrogen discharge line 4. The first discharge line 4 ensures the fluid connection of components arranged downstream from the electrolyser 1 on said first discharge line 4. The following description is made by starting from the electrolyser 1 and by following the circulation direction in the first discharge line 4 from the electrolyser 1. The first discharge line 4 ensures the fluid connection of the electrolyser 1 with the first heat exchange module 5, more preferably with the second heat exchanger 5b, then the fluid connection of the second heat exchanger 5b to the first heat exchanger 5a, then the fluid connection of the first heat exchanger 5a to the preliminary treatment stage 25, more specifically to the heat exchanger 7, preferably air cooler, then the fluid connection of the air cooler 7 to the liquid/gas separator 8. Then, the first discharge line 4 ensures the fluid connection of the liquid/gas separator 8 to the ejector 9, then the fluid connection of the ejector 9 to the first treatment stage 26, more specifically to the heat exchanger 10, preferably the air cooler 10, then the fluid connection of the air cooler 10 to the liquid/gas separator 12, then the fluid connection of the liquid/gas separator 12 to the compressor 13, then the fluid connection of the air cooler 14 to the compressor 15, then the fluid connection of the compressor 15 to the second treatment stage, more specifically to the heat exchanger 16, preferably air cooler 16, then the fluid connection of the air cooler 16 to the liquid/gas separator 27.

Preferably, the electrolyser 1 is fluidly connected to a second dioxygen discharge line 3. The second discharge line 3 ensures the fluid connection of components arranged downstream from the electrolyser 1 on said second discharge line 3. The following description is made by starting the electrolyser 1 and by following the circulation direction in the second discharge line 3 from the electrolyser 1. The second discharge line 3 ensures the fluid connection of the electrolyser 1 with the second heat exchange module 11, more preferably with the second heat exchanger 11b, then the fluid connection of the second heat exchanger 11b to the first heat exchanger 11a.

Preferably, the electrolyser 1 is fluidly connected to the second air supply line 18. The second supply line 18 ensures the fluid connection of components arranged upstream from the electrolyser 1 on said second supply line 18. The second supply line ensures fluid connection of the compressor 19 to the first heat exchanger 11a, then, the fluid connection of the first heat exchanger 11a to the second heat exchanger 11b, then the fluid connection of the second heat exchanger 11b to the electrical heater 23, then the fluid connection of the electrical heater 23 to the electrolyser 1.

The system comprises fluid connections described below and forming part of the different supply 2, 18 and discharge 3, 4 lines of the system.

Concerning the first supply line 2, it advantageously comprises a fluid connection A connected to the inlet of the expansion valve 6.

Advantageously, the first supply line 2 comprises a fluid connection B connected between the outlet of the expansion valve 6 and the inlet of the first heat exchanger 5a of the heat exchanger module 5.

Advantageously, the first supply line 2 comprises a fluid connection C connected between the outlet of the first heat exchanger 5a and the inlet of the second heat exchanger 5b.

Advantageously, the first supply line 2 comprises a fluid connection D connected between the outlet of the second heat exchanger 5b and the inlet of the electrical heater 24.

Advantageously, the first supply line 2 comprises a fluid connection E connected between the outlet of the electrical heater 24 to the inlet of the electrolyser 1.

Concerning the first discharge line 4, it advantageously comprises a first fluid connection F between the outlet of the electrolyser 1 and the inlet of the second heat exchanger 5b of the first heat exchange module 5.

Advantageously, the first discharge line 4 comprises a fluid connection G between the outlet of the second heat exchanger 5b of the first heat exchange module 5 and the inlet of the first heat exchanger 5a of the first heat exchange module 5.

Advantageously, the first discharge line 4 comprises a fluid connection H between the outlet of the first heat exchanger 5a and the inlet of the air cooler 7.

Advantageously, the first discharge line 4 comprises a fluid connection I between the outlet of the air cooler 7 and the inlet of the separator 8.

Advantageously, the first discharge line 4 comprises a fluid connection J between the outlet of the separator 8 and the ejector 9.

Advantageously, the first discharge line 4 comprises a fluid connection K between the outlet of the ejector 9 and the inlet of the air cooler 10.

Advantageously, the first discharge line 4 comprises a fluid connection L between the outlet of the air cooler 10 and the inlet of the separator 12.

Advantageously, the first discharge line 4 comprises a fluid connection M between the outlet of the separator 12 and the inlet of the compressor 13.

Advantageously, the first discharge line 4 comprises a fluid connection N between the outlet of the compressor 13 and the inlet of the air cooler 14.

Advantageously, the first discharge line 4 comprises a fluid connection O between the outlet of the air cooler 14 and the inlet of the compressor 15.

Advantageously, the first discharge line 4 comprises a fluid connection P between the outlet of the compressor 15 and the inlet of the air cooler 16.

Advantageously, the first discharge line 4 comprises a fluid connection Q between the outlet of the air cooler 16 and the inlet of the separator 17.

Advantageously, the first discharge line 4 comprises a fluid connection R ensuring the exiting of the dihydrogen from the separator 17.

Concerning the second dioxygen discharge line 3, it advantageously comprises a fluid connection 100 between the outlet of the electrolyser 1 and the inlet of the second heat exchanger 11b of the second heat exchange module 11.

Advantageously, the second discharge line 3 comprises a fluid connection 101 between the outlet of the second heat exchanger 11b and the inlet of the first heat exchanger 11a of the second heat exchange module 11.

Advantageously, the second discharge line 3 comprises a fluid connection 102 between the outlet of the first heat exchanger 11a and the exterior.

Concerning the second air supply line 4, it advantageously comprises a fluid connection 110 entering into the compressor 19.

Advantageously, the second supply line 4 comprises a fluid connection 111 between the outlet of the compressor 19 and the inlet of the first heat exchanger 11a of the second heat exchange module 11.

Advantageously, the second supply line 4 comprises a fluid connection 112 between the outlet of the first heat exchanger 11a and the inlet of the second heat exchanger 11b of the second heat exchange module 11.

Advantageously, the second supply line 4 comprises a fluid connection 113 between the outlet of the second heat exchanger 11b and the inlet of the electrical heater 13.

Advantageously, the second supply line 4 comprises a fluid connection 114 between the outlet of the electrical heater 13 and the inlet of the electrolyser 1.

In operation, the steam reaches the first steam supply line 2. The fluid connection A is advantageously connected to the inlet of the expansion valve 6. The water recycling line 21 can be fluidly connected to the first supply line 2.

The steam exits from the expansion valve 6 by the fluid connection B and enters, preferably directly, into the first heat exchange module 5, preferably in the first heat exchanger 5a. The steam is heated in the first heat exchanger 5a by the fluid connection C and enters, preferably directly, into the second heat exchanger 5b. The steam is again heated in the second heat exchanger 5b by recovery of the calories from the dihydrogen circulating in the second heat exchanger 5b. The overheated steam exits from the second heat exchanger 5b by the fluid connection D and enters, preferably directly, into the electrical heater 24, if needed. The electrical heater 24 ensures the last increase in temperature possibly necessary such that the steam reaches a predefined target temperature to enter into the electrolyser 1. The steam exits from the electrical heater 24 by the fluid connection E and enters, preferably directly, into the electrolyser 1.

The electrolyser 1 is supplied with electric current according to a voltage and a predefined intensity allowing to ensure the electrolysis and therefore the production of dihydrogen and dioxygen.

The dihydrogen exits from the electrolyser 1 by the first discharge line, by the fluid connection F and enters, preferably directly, into the first heat exchange module 5, preferably the second heat exchanger 5b. The dihydrogen exits from the electrolyser in a hot gaseous state, it is necessary to lower its temperature to use it and/or to store it. The calories from the dihydrogen are therefore recovered by the first supply line and more specifically, the steam circulating there. In the second heat exchanger 5b, the dihydrogen has its temperature lowered by transfer of calories for the benefit of the steam circulating in the second heat exchanger 5b. The cooled dihydrogen exits from the second heat exchanger 5b by the fluid connection G and enters, preferably directly, into the first heat exchanger 5a. In the first heat exchanger 5, the dihydrogen again has its temperature lowered by transfer of calories for the benefit of the steam circulating in the first heat exchanger 5a. The cooled dihydrogen exits from the first heat exchanger 5a by the fluid connection H and enters, preferably directly, into the air cooler 7. By passing into the air cooler 7, the dihydrogen is cooled. The dihydrogen exits from the air cooler 7 by the fluid connection I and enters, preferably directly, into the separator 8 ensuring the condensation of the water contained in the dihydrogen. The dihydrogen exits from the liquid/gas separator 8 by the fluid connection J and enters, preferably directly, into the ejector 9 which injects steam into the first dihydrogen discharge line 4. The dihydrogen mixed with the steam injected by the ejector exits from the ejector by the fluid connection K and enters, preferably directly, into the air cooler 10 where it undergoes a cooling ensuring the condensation of some of the steam of the mixture. The dihydrogen, preferably the condensed gaseous dihydrogen, steam, liquid water mixture exits from the air cooler by the fluid connection L and enters, preferably directly, into the separator 12, where the liquid water is separated from the gaseous phase. The gaseous phase exits from the separator 12 and enters, preferably directly, into the compressor 13 by the fluid connection M and undergoes, if needed, another compression in view of another condensation. The dihydrogen exits from the compressor 13 by the fluid connection N and enters, preferably directly, into the air cooler 14. The dihydrogen exits from the air cooler 14 by the fluid connection O and enters, preferably directly, into the compressor 15 from where it exits by the fluid connection P and enters, preferably directly, into the air cooler 16 or a heat exchanger ensuring the cooling of the dihydrogen. The dihydrogen exits from the air cooler 16 or a heat exchanger by the fluid connection Q and enters, preferably directly, into the liquid/gas separator 20 ensuring the condensation of the dihydrogen. The condensed dihydrogen exits from the liquid/gas separator 17 by the fluid connection R and can be used or stored. The condensed liquid water recovered from the liquid/gas separator 8, 12, 17 can be recycled in the first steam supply line 2 by fluid connection with the water recycling line 21.

The dioxygen produced by the electrolyser exits by the second discharge line 3, by the fluid connection 100 and enters, preferably directly, into the second heat exchange module 11, preferably the second heat exchanger 11b. The dioxygen exits from the electrolyser in the hot gaseous state, it is necessary to lower its temperature to release it into the air. The calories from the dioxygen are therefore recovered, advantageously by the second supply line 10 and more specifically, the air circulating there. In the second heat exchanger 11b, the dioxygen has its temperature lowered by transfer of calories for the benefit of the air circulating in the second heat exchanger 11b. The cooled dioxygen exits from the second heat exchanger 11b by the fluid connection 101 and enters, preferably directly, into the first heat exchanger 11a. In the first heat exchanger 11a, the dioxygen again has its temperature lowered by transfer of calories for the benefit of the air circulating in the first heat exchanger 11a. The cooled dioxygen exits from the first heat exchanger 11a by the fluid connection 102 and is released into the air.

According to a possibility, the air is supplied to the electrolyser 1. The air reaches the second supply line 10 by the fluid connection 110 and enters, preferably directly, into the compressor 19. The air is compressed by the compressor 19 and its temperature increases. The air exits from the compressor 19 by the fluid connection 111 and enters, preferably directly, into the second heat exchange module 11, preferably into the first heat exchanger 11a. The air is heated in the first heat exchanger 11a by recover of the calories from the dioxygen circulating in the first heat exchanger 11a. The overheated air exits from the first heat exchanger 11a by the fluid connection 112 and enters, preferably directly, into the second heat exchanger 11b. The air is again heated in the second heat exchanger 11b by recovery of the calories from the dioxygen circulating in the second heat exchanger 11b. The overheated air exits from the second heat exchanger 11b by the fluid connection 113 and enters, preferably directly, into the electrical heater 23, if needed. The electrical heater 23 ensures the last increase in temperature possibly necessary such that the air reaches a predefined target temperature to enter into the electrolyser 1. The air exits from the electrical heater 23 by the fluid connection 114 and enters, preferably directly, into the electrolyser 1.

### EXAMPLE

A heat source in the form of steam at 150° C. is used to supply the SOEC by the steam at 150° C., 2.3 bar and to supply the ejector 9 by the steam at 150° C., 4 bars.

The SOEC operates in this almost atmospheric imprinted example and hydrogen is stored at a pressure of 30 bars.

The invention is not limited to the embodiments described above, and extends to all the embodiments covered by the invention.

### LIST OF REFERENCES

1 Electrolyser
2 First steam supply line
3 Second dioxygen discharge line
4 First dihydrogen discharge line
5a First heat exchanger of the first heat exchange module
5b Second heat exchanger of the first heat exchange module
6 expansion valve
7 Air cooler
8 Liquid/gas separator
9 Ejector
10 Air cooler
11a First heat exchanger of the second heat exchange module
11b Second heat exchanger of the second heat exchange module
12 Liquid/gas separator
13 Compressor
14 Air cooler
15 Compressor
16 Air cooler
17 Liquid/gas separator
18 Second air supply line
19 Compressor
20 Source steam inlet
21 Water recycling line
22 Recycled steam inlet in the method (HTE steam)
23. Electrical heater
24. Electrical heater
25 Preliminary treatment stage
26. First treatment stage
27. Second treatment stage
A Fluid connection entering into the expansion valve 6
B Fluid connection between the expansion valve 6 and the first heat exchanger of the first heat exchange module 5a
C Fluid connection between the first heat exchanger of the first heat exchange module 5a and the second heat exchanger of the first heat exchange module 5b
D Fluid connection between the second heat exchanger 5b and the heater 14
E Fluid connection between the heater 14 and the electrolyser 1
F Fluid connection between the electrolyser 1 and the second heat exchanger 5b
G Fluid connection between the second heat exchanger 5b and the first heat exchanger 5a
H Fluid connection between the first heat exchanger 5a and the first air cooler 7
I Fluid connection between the first air cooler 7 and the first liquid/gas separator 8
J Fluid connection between the first liquid/gas separator 8 and the ejector 9
K Fluid connection between the ejector 9 and the air cooler 10
L Fluid connection between the air cooler 10 and the liquid/gas separator 12
M Fluid connection between the separator 12 and the compressor 13
N Fluid connection between the compressor 13 and the air cooler 14
O Fluid connection between the air cooler 14 and the compressor 15
P Fluid connection between the compressor 15 and the air cooler 16
Q Fluid connection between the air cooler 16 and the separator 17
R Fluid connection exiting from the separator 17
100 Fluid connection between the electrolyser 1 and the second heat exchanger 11b
101 Fluid connection between the second heat exchanger 11b and the first heat exchanger 11a
102 Fluid connection between the first heat exchanger 11a and the exterior
110 Air inlet fluid connection in the compressor 19
111 Fluid connection between the compressor 19 and the first heat exchanger 11a
112 Fluid connection between the first heat exchanger 11a and the second heat exchanger 11b
113 Fluid connection between the second heat exchanger 11b and the heater 23
114 Fluid connection between the heater 23 and the electrolyser 1

1. A system comprising:
a high temperature electrolyser (HTE),
a first line for supplying steam to the electrolyser,
a first line for discharging dihydrogen from the electrolyser,
a second line for discharging dioxygen from the electrolyser,
a first heat exchange module between the first steam supply line and the first dihydrogen discharge line, and
a steam ejector arranged downstream from the first heat exchange module on the first dihydrogen discharge line and configured to inject steam into the first dihydrogen discharge line.

2. The system according to the preceding claim 1, comprising at least one compressor arranged downstream from the ejector.

3. The system according to the preceding claim 2, comprising at least two compressors arranged in series and a heat exchanger arranged between two compressors.

4. The system according to claim 1, comprising at least two ejectors arranged in series.

5. The system according to claim 2, comprising a first dihydrogen treatment stage arranged on the first dihydrogen discharge line downstream from the ejector.

6. The system according to claim 5, wherein the compressor is arranged downstream from the first treatment stage.

7. The system according to claim 5, wherein the first treatment stage comprises a heat exchanger and/or a liquid/gas separator.

8. The system according to claim 1, comprising a preliminary dihydrogen treatment stage arranged on the first dihydrogen discharge line upstream from the ejector.

9. The system according to claim 2, comprising a second dihydrogen treatment stage arranged on the first dihydrogen discharge line downstream from the compressor.

10. The system according to claim 1, comprising a second line for supplying the electrolyser configured to supply the electrolyser with air.

11. The system according to claim 10, comprising a second heat exchange module between the second air supply line and the second dioxygen discharge line.

12. The system according to claim 7, comprising a water recycling line fluidly connected to at least one from among the preliminary treatment stage, the first treatment stage and the second treatment stage.

13. The system according to claim 1, wherein the steam is fatal steam.
